(19) United States
(12) Patent Application Publication
(10) Pub. No.: US 2018/0322627 A1
(43) Pub. Date: Nov. 8, 2018

(54) METHODS AND SYSTEMS FOR ACQUISITION OF MEDICAL IMAGES FOR AN ULTRASOUND EXAM

(71) Applicant: General Electric Company, Schenectady, NY (US)

(72) Inventors: OLIVIER GERARD, Horten (NO); Elina Sokulin, Tirat Carmel (IL)

(21) Appl. No.: 15/587,568

(22) Filed: May 5, 2017

(51) Int. Cl. G06T 7/00; G06F 3/0484

(52) U.S. Cl. CPC G06T 7/0012; G06T 2207/10132; G06T 2200/24; G06F 3/04847

(57) ABSTRACT

Systems and methods described herein generally relate to acquiring medical images for a protocol of an ultrasound exam. The systems and methods select a protocol of an ultrasound exam. The protocol includes a plurality of protocol defined fields of view (FOVs) of an anatomical structure of interest. The system and methods generate a medical image of the anatomical structure of interest based on ultrasound data acquired from an ultrasound probe, and identify a candidate FOV associated with the anatomical structure of interest based on anatomical markers of the medical image. The systems and methods also indicate on a graphical user interface (GUI) that the candidate FOV is acquired such that a select characteristic of a first user interface component of the GUI representing the candidate FOV is adjusted while the remaining user interface components representing the plurality of protocol defined FOVs do not include the select characteristic.

### FIELD

Embodiments described herein generally relate to acquiring medical images for a protocol of an ultrasound exam.

### BACKGROUND OF THE INVENTION

During an ultrasound exam a series of medical images and a series of measurements can be performed on the medical images. The series of medical images represent different field of views of an anatomical structure of interest. The series of medical images and measurements define a protocol for the ultrasound exam. The protocol is conventionally known in advance, or the clinician may define the protocol prior to the ultrasound exam. The protocol is conventionally presented as a list of individual steps that the clinician has to perform. Specifically, the clinician must successively acquire and perform the measurements at the predefined order on the list defined by the protocol. However, the protocol can be too rigid for the clinician. The protocol limits the liberty of the clinician to choose which medical image to acquire next, and adds more interface requirements for the clinician to select next steps. Further, due to the restrictions of the protocol, clinicians may ignore the protocol during the ultrasound exam leaving missing medical images creating inconsistencies between the ultrasound exams of a patient.

### BRIEF DESCRIPTION OF THE INVENTION

In an embodiment, a computer implemented method (e.g., for acquisition of medical images for an ultrasound exam) is provided. The method includes selecting a protocol of an ultrasound exam. The protocol includes a plurality of protocol defined fields of view (FOVs) of an anatomical structure of interest. The method includes generating a medical image of the anatomical structure of interest based on ultrasound data acquired from an ultrasound probe, and identifying a candidate FOV associated with the anatomical structure of interest based on anatomical markers of the medical image. The method also includes indicating on a graphical user interface (GUI) that the candidate FOV is acquired. The indicating operation adjusts a select characteristic of a first user interface component of the GUI representing the candidate FOV such that the remaining user interface components representing the plurality of protocol defined FOVs do not include the select characteristic.

In an embodiment, a system (e.g., a medical imaging system) is provided. The system includes an ultrasound probe configured to acquire ultrasound data of an anatomical structure of interest, a display, and a controller circuit. The controller circuit is configured to select a protocol of an ultrasound exam. The protocol includes a plurality of protocol defined fields of view (FOVs) of the anatomical structure of interest. The controller circuit is configured to generate a medical image of the anatomical structure of interest based on ultrasound data acquired from an ultrasound probe, and identify a candidate FOV associated with the anatomical structure of interest based on anatomical markers of the medical image. The controller circuit is configured to indicate on a graphical user interface (GUI) that the candidate FOV is acquired such that a select characteristic of a first user interface component of the GUI representing the candidate FOV is adjusted while the remaining user interface components representing the plurality of protocol defined FOVs do not include the select characteristic.

In an embodiment, a tangible and non-transitory computer readable medium is provided. The tangible and non-transitory computer readable medium includes one or more programmed instructions configured to direct one or more processors to select a protocol of an ultrasound exam. The protocol includes a plurality of protocol defined fields of view (FOVs) of an anatomical structure of interest. The one or more programmed instructions are configured to direct the one or more processors to generate a medical image of the anatomical structure of interest based on ultrasound data acquired from an ultrasound probe, and identify a candidate FOV associated with the anatomical structure of interest based on anatomical markers of the medical image. The one or more programmed instructions are configured to direct the one or more processors to indicate on a graphical user interface (GUI) that the candidate FOV is acquired such that a select characteristic of a first user interface component of the GUI representing the candidate FOV is adjusted while the remaining user interface components representing the plurality of protocol defined FOVs do not include the select characteristic. The select characteristic represents at least one of a color, a position, an animation, a size, a text format of the first user interface component.

### BRIEF DESCRIPTION OF THE DRAWINGS

FIGS. 1 illustrates a schematic block diagram of an embodiment of a medical imaging system.

FIG. 2 illustrates an embodiment of a neural network of an image analysis algorithm.

FIG. 3 illustrates a swim lane diagram of an embodiment of a method for acquisition of medical images for an ultrasound exam.

FIG. 4 illustrates a medical image of an embodiment having an anatomical structure of interest.

FIG. 5 illustrates an embodiment of an embodiment of a graphical user interface shown on a display.

FIG. 6 illustrates an embodiment of diagnostic measurement tools of a graphical user interface shown on a display.

### DETAILED DESCRIPTION OF THE INVENTION

The following detailed description of certain embodiments will be better understood when read in conjunction with the appended drawings. To the extent that the figures illustrate diagrams of the functional modules of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments described herein generally relate to acquiring medical images for a protocol of an ultrasound exam. For example, a medical imaging system is provided herein. The medical imaging system is configured to acquire medical images of an anatomical structure of interest corresponding to a protocol of an ultrasound exam. The anatomical structure of interest may be an organ (e.g., heart, kidney, lung, liver, bladder, brain, neonatal brain, embryo, abdomen, and/or the like), vascular structure (e.g., vein), tissue (e.g., breast tissue, liver tissue, cardiac tissue, prostate tissue, and/or the like), bone, and/or the like. The protocol may include a plurality of protocol-defined field of views (FOVs) of an anatomical structure of interest. The FOV may represent an angle of rotation, orientation, and/or a cross section within the anatomical structure of interest. For example, the anatomical structure of interest may be a heart, the FOV may be an apical four chamber of the heart.

The medical imaging system is configured to execute an image analysis algorithm to identify the FOV of the medical image in real-time. The image analysis algorithm may be defined based on a machine learning algorithm. The image analysis algorithm is configured to identify the FOV of the anatomical structure of interest within the medical image in real-time during the ultrasound exam. When the FOV is identified by the medical imaging system, the medical imaging system may be configured to identify the FOV relative to the protocol. If the FOV is included in the protocol, the medical imaging system may indicate to the clinician the FOV has been acquired. Optionally, the medical imaging system is configured to determine if the FOV of the protocol includes an anatomical measurement of the anatomical structure of interest. The anatomical measurement may correspond to measuring a volume, an area, a surface area, a wall thickness, a blood flow, and/or the like of the anatomical structure of interest. When the anatomical measurement is needed based on the protocol, the medical imaging system may be configured to generate diagnostic measurement tools. The diagnostic measurement tools are configured to enable the clinician to perform the anatomical measurement.

Optionally, the medical imaging system may be configured to indicate a completion score and/or rating indicating an amount of FOVs and/or anatomical measurements that are needed to complete the ultrasound exam based on the protocol. Additionally or alternatively, the medical imaging system may be configured to determine that the FOV has already been acquired. For example, the medical imaging system may indicate to the clinician that the FOV has already been acquired and/or to adjust a position of an ultrasound probe.

A technical effect of at least one embodiment described herein enables a flexible approach for completing protocols of an ultrasound exam. A technical effect of at least one embodiment described herein enables a flexibility to the clinician to freely position the ultrasound probe without needing to follow a strict list for the protocol. A technical effect of at least one embodiment described herein enables a medical imaging system in real-time to acquire and store FOVs of an anatomical structure of interest based on a protocol of an ultrasound exam.

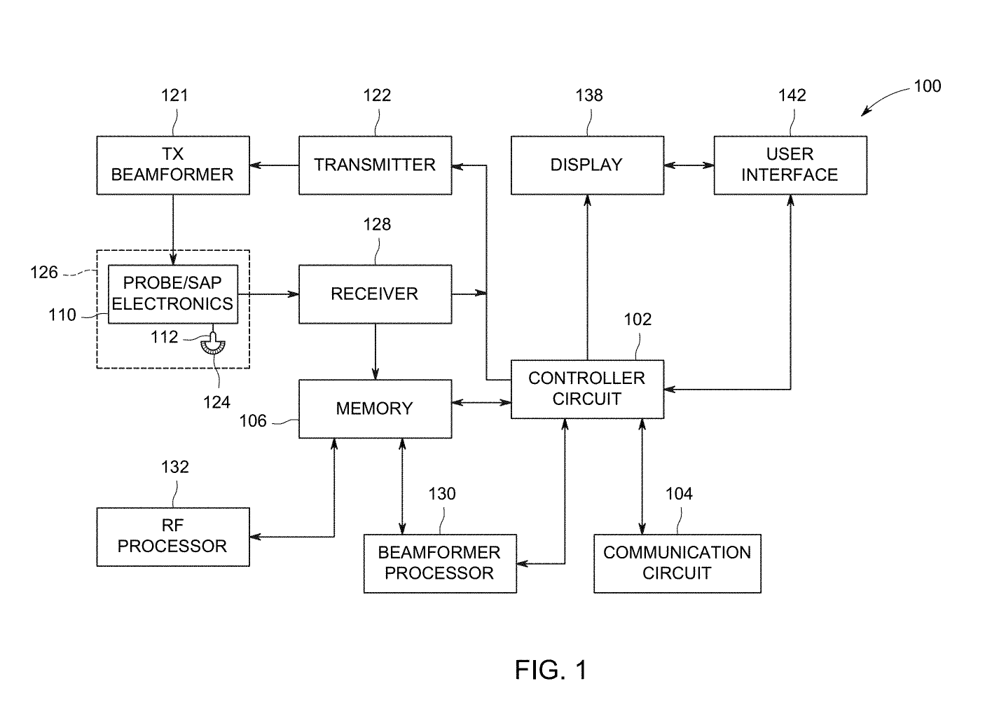

FIG. 1 illustrates a schematic block diagram of an embodiment of a medical imaging system 100. For example, the medical imaging system 100 may represent an ultrasound imaging system. The medical imaging system 100 may include a controller circuit 102 operably coupled to a communication circuit 104, a display 138, a user interface 142, an ultrasound probe 126, and a memory 106.

The controller circuit 102 is configured to control the operation of the medical imaging system 100. The controller circuit 102 may include one or more processors. Optionally, the controller circuit 102 may include a central processing unit (CPU), one or more microprocessors, a graphics processing unit (GPU), or any other electronic component capable of processing inputted data according to specific logical instructions. Optionally, the controller circuit 102 may include and/or represent one or more hardware circuits or circuitry that include, are connected with, or that both include and are connected with one or more processors, controllers, and/or other hardware logic-based devices. Additionally or alternatively, the controller circuit 102 may execute instructions stored on a tangible and non-transitory computer readable medium (e.g., the memory 106).

The controller circuit 102 may be operably coupled to and/or control a communication circuit 104. The communication circuit 104 is configured to receive and/or transmit information with one or more alternative medical imaging systems, a remote server, and/or the like along a bi-directional communication link. The remote server may represent a database that includes patient information, machine learning algorithms, remotely stored medical images from prior scanning and/or clinician sessions of a patient, and/or the like. The communication circuit 104 may represent hardware that is used to transmit and/or receive data along a bi-directional communication link. The communication circuit 104 may include a transceiver, receiver, transceiver and/or the like and associated circuitry (e.g., antennas) for wired and/or wirelessly communicating (e.g., transmitting and/or receiving) with the one or more alternative medical imaging systems, the remote server, and/or the like. For example, protocol firmware for transmitting and/or receiving data along the bi-directional communication link may be stored in the memory 106, which is accessed by the controller circuit 102. The protocol firmware provides the network protocol syntax for the controller circuit 102 to assemble data packets, establish and/or partition data received along the bi-directional communication links, and/or the like.

The bi-directional communication links may be a wired (e.g., via a physical conductor) and/or wireless communication (e.g., utilizing radio frequency (RF)) link for exchanging data (e.g., data packets) between the one or more alternative medical imaging systems, the remote server, and/or the like. The bi-directional communication links may be based on a standard communication protocol, such as Ethernet, TCP/IP, WiFi, 802.11, a customized communication protocol, Bluetooth, and/or the like.

The controller circuit 102 is operably coupled to the display 138 and the user interface 142. The display 138 may include one or more liquid crystal displays (e.g., light emitting diode (LED) backlight), organic light emitting diode (OLED) displays, plasma displays, CRT displays, and/or the like. The display 138 may display patient information, one or more medical images and/or videos, components of a graphical user interface, one or more 2D, 3D, or 4D ultrasound image data sets from ultrasound data stored in the memory 106 or currently being acquired in real-time, anatomical measurements, diagnosis, treatment information, and/or the like received by the display 138 from the controller circuit 102.

The user interface 142 controls operations of the controller circuit 102 and the medical imaging system 100. The user interface 142 is configured to receive inputs from the clinician and/or operator of the medical imaging system 100. The user interface 142 may include a keyboard, a mouse, a touchpad, one or more physical buttons, and/or the like. Optionally, the display 138 may be a touch screen display, which includes at least a portion of the user interface 142. For example, a portion of the user interface 142 may correspond to a graphical user interface (GUI) generated by the controller circuit 102, which is shown on the display 138. The touch screen display can detect a presence of a touch from the operator on the display 138 and can also identify a location of the touch with respect to a surface area of the display 138. For example, the user may select one or more user interface components of the GUI shown on the display by touching or making contact with the display 138. The user interface components may correspond to graphical icons, textual boxes, menu bars, and/or the like shown on the display 138. The user interface components may be selected, manipulated, utilized, interacted with, and/or the like by the clinician to instruct the controller circuit 102 to perform one or more operations as described herein. The touch may be applied by, for example, at least one of an individual's hand, glove, stylus, and/or the like.

The memory 106 includes parameters, algorithms, protocols of one or more ultrasound exams, data values, and/or the like utilized by the controller circuit 102 to perform one or more operations described herein. The memory 106 may be a tangible and non-transitory computer readable medium such as flash memory, RAM, ROM, EEPROM, and/or the like. The memory 106 may include a set of machine learning algorithms (e.g., convolutional neural network algorithms, deep learning algorithms, decision tree learning algorithms, and/or the like) configured to define an image analysis algorithm. The controller circuit 102, when executing the image analysis algorithm, is configured to identify the FOV of the anatomical structure of interest of the medical image. Optionally, the image analysis algorithm may be received along one of the bi-directional communication links via the communication circuit 104 and stored in the memory 106.

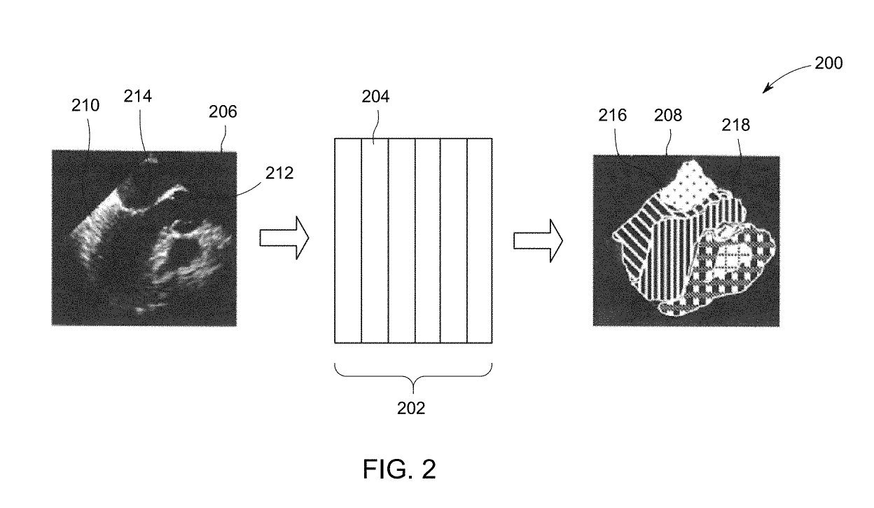

The image analysis algorithm may be defined by one or more machine learning algorithms to identify the FOV of the anatomical structure of interest based on one or more anatomical markers (e.g., boundaries, thickness, changes in pixel values, valves, a cavity, chambers, border or lining, a cellular wall, vascular structure, and/or the like) within the medical image, modality or mode (e.g., colorflow) of the medical image, and/or the like. The one or more anatomical markers may represent features of the pixels and/or voxels of the medical image such as a histogram orient gradients, blob features, covariance features, binary pattern features, and/or the like. For example, the anatomical markers may represent anatomical features and/or structures of the anatomical structure of interest, fiducial markers, and/or the like. In connection with FIG. 2, the image analysis algorithm 200 may be defined using prediction of object identification within the medical images using one or more deep neural networks.

FIG. 2 illustrates an embodiment of a neural network 202 of the image analysis algorithm 200. The image analysis algorithm 200 may correspond to an artificial neural network formed by the controller circuit 102 and/or the remote server. The image analysis algorithm 200 may be divided into two or more layers 204, such as an input layer that receives an input image 206, an output layer that outputs an output image 208, a FOV layer, and/or one or more intermediate layers. The layers 204 of the neural network 202 represent different groups or sets of artificial neurons, which can represent different functions performed by the controller circuit 102 on the input image 206 (e.g., an acquired and/or generated medical image by the medical imaging system 100) to identify objects of the input image 206, and determine the FOV of the anatomical structure of interest shown in the input image 206. The artificial neurons in the layers 204 of the neural network 202 can examine individual pixels 214 in the input image 206. The artificial neurons apply different weights in the functions applied to the input image 206 to attempt to identify the objects in the input image 206. The output image 208 is generated by the neural network 202 by assigning or associating different pixels in the output image 208 with different anatomical markers based on analysis of characteristics of the pixels.

The image analysis algorithm 200 is defined by a plurality of training images may be grouped into different FOVs of the anatomical structure of interest. The training images may represent different orientations and/or cross-sections of the anatomical structure of interest corresponding to different FOVs. One of the neuron layers 204 corresponding to the FOV layer, may define a mathematical function based on relation of the anatomical markers with respect to each other to determine the FOV of the anatomical structure of interest shown in the input image 206.

Additionally or alternatively, the image analysis algorithm may be defined by the controller circuit 102 based on a classification model. The classification model may correspond to a machine learning algorithm based on a classifier (e.g., random forest classifier, principal component analysis, and/or that like) that is configured to identify and/or assign anatomical markers into a plurality of categories or classes based on an overall shape, spatial position with respect to the anatomical structure of interest, intensity, and/or the like.

Based on a relation of the anatomical markers with respect to each other, modality, and/or the like the controller circuit 102 executing the image analysis algorithm (e.g., the image analysis algorithm 200) may determine the FOV of the anatomical structure of interest. The relation may include an orientation of the anatomical markers with respect to each other. For example, based on an orientation of anatomical markers representing cavities of the anatomical structure of interest may be utilized by the controller circuit 102 to identify the FOV. If the orientation of the anatomical marker changes within the image (e.g., the input image 206), the controller circuit 102 may determine that the FOV is at an angle and the transducer array 112 is not perpendicular to the anatomical structure of interest. Additionally or alternatively, the relation may include a distance(s) and/or spatial position between at least two of the anatomical markers. The distance may correspond to a spacing between boundaries of the anatomical makers. Changes in the spacing between at least two anatomical markers may indicate that the FOV is at an angle and the transducer array 112 is not perpendicular to the anatomical structure of interest.

Additionally or alternatively, the controller circuit 102 may define separate image analysis algorithms tailored and/or configured to different select anatomical structures of interest. For example, a plurality of image analysis algorithms may be stored in the memory 106. Each of the plurality of image analysis algorithms may be tailored and/or configured based on different training images (e.g., sets of input images 206) to configure the layers 204 of the different neural networks 202 to select anatomical structures of interest, classification models, supervised learning models, and/or the like. Based on the protocol selected and/or defined by the clinician, the controller circuit 102 may select one of the plurality of image analysis algorithms corresponding to the anatomical structure of interest of the protocol.

It may be noted that the machine learning algorithms utilized to define the image analysis algorithm are examples; additional methods may be available for a person of ordinary skill in the art.

Returning to FIG. 1, the medical imaging system 100 may include the ultrasound probe 126 having a transmitter 122, transmit beamformer 121 and probe/SAP electronics 110. The probe/SAP electronics 110 may be used to control the switching of the transducer elements 124. The probe/SAP electronics 110 may also be used to group transducer elements 124 into one or more sub-apertures.

The ultrasound probe 126 may be configured to acquire ultrasound data or information from the anatomical structure of interest (e.g., organ, blood vessel, heart, bone, and/or the like) of the patient. The ultrasound probe 126 is communicatively coupled to the controller circuit 102 via the transmitter 122. The transmitter 122 transmits a signal to a transmit beamformer 121 based on acquisition settings received by the controller circuit 102. The acquisition settings may define an amplitude, pulse width, frequency, gain setting, scan angle, power, time gain compensation (TGC), resolution, and/or the like of the ultrasonic pulses emitted by the transducer elements 124. The transducer elements 124 emit pulsed ultrasonic signals into the patient (e.g., a body). The acquisition settings may be defined by the user operating the user interface 142. The signal transmitted by the transmitter 122 in turn drives a plurality of transducer elements 124 within a transducer array 112.

The transducer elements 124 emit pulsed ultrasonic signals into a body (e.g., patient) or volume corresponding to the acquisition settings along one or more scan planes. The ultrasonic signals may include, for example, one or more reference pulses, one or more pushing pulses (e.g., shear-waves), and/or one or more pulsed wave Doppler pulses. At least a portion of the pulsed ultrasonic signals backscatter from the anatomical structure of interest (e.g., organ, bone, heart, breast tissue, liver tissue, cardiac tissue, prostate tissue, neonatal brain, embryo, abdomen, and/or the like) to produce echoes. The echoes are delayed in time and/or frequency according to a depth or movement, and are received by the transducer elements 124 within the transducer array 112. The ultrasonic signals may be used for imaging, for generating and/or tracking shear-waves, for measuring changes in position or velocity within the anatomic structure, differences in compression displacement of the tissue (e.g., strain), and/or for therapy, among other uses. For example, the probe 126 may deliver low energy pulses during imaging and tracking, medium to high energy pulses to generate shear-waves, and high energy pulses during therapy.

The transducer elements 124 convert the received echo signals into electrical signals, which may be received by a receiver 128. The receiver 128 may include one or more amplifiers, an analog to digital converter (ADC), and/or the like. The receiver 128 may be configured to amplify the received echo signals after proper gain compensation and convert these received analog signals from each transducer element 124 to digitized signals sampled uniformly in time. The digitized signals representing the received echoes are stored in memory 106, temporarily. The digitized signals correspond to the backscattered waves received by each transducer element 124 at various times. After digitization, the signals still may preserve the amplitude, frequency, phase information of the backscatter waves.

Optionally, the controller circuit 102 may retrieve the digitized signals stored in the memory 106 to prepare for the beamformer processor 130. For example, the controller circuit 102 may convert the digitized signals to baseband signals or compressing the digitized signals.

The beamformer processor 130 may include one or more processors. Optionally, the beamformer processor 130 may include a central processing unit (CPU), one or more microprocessors, or any other electronic component capable of processing inputted data according to specific logical instructions. Additionally or alternatively, the beamformer processor 130 may execute instructions stored on a tangible and non-transitory computer readable medium (e.g., the memory 106) for beamforming calculations using any suitable beamforming method such as adaptive beamforming, synthetic transmit focus, aberration correction, synthetic aperture, clutter reduction and/or adaptive noise control, and/or the like. Optionally, the beamformer processor 130 may be integrated with and/or a part of the controller circuit 102. For example, the operations described as being performed by the beamformer processor 130 may be configured to be performed by the controller circuit 102.

The beamformer processor 130 performs beamforming on the digitized signals of transducer elements and outputs a radio frequency (RF) signal. The RF signal is then provided to an RF processor 132 that processes the RF signal. The RF processor 132 may include one or more processors. Optionally, the RF processor 132 may include a central processing unit (CPU), one or more microprocessors, or any other electronic component capable of processing inputted data according to specific logical instructions. Additionally or alternatively, the RF processor 132 may execute instructions stored on a tangible and non-transitory computer readable medium (e.g., the memory 106). Optionally, the RF processor 132 may be integrated with and/or a part of the controller circuit 102. For example, the operations described as being performed by the RF processor 132 may be configured to be performed by the controller circuit 102.

The RF processor 132 may generate different ultrasound image data types and/or modes, e.g., B-mode, color Doppler (e.g., colorflow, velocity/power/variance), tissue Doppler (velocity), and Doppler energy, for multiple scan planes or different scanning patterns based on the predetermined settings of the first model. For example, the RF processor 132 may generate tissue Doppler data for multi-scan planes. The RF processor 132 gathers the information (e.g., I/Q, B-mode, color Doppler, tissue Doppler, and Doppler energy information) related to multiple data slices and stores the data information, which may include time stamp and orientation/rotation information, in the memory 106.

Alternatively, the RF processor 132 may include a complex demodulator (not shown) that demodulates the RF signal to form IQ data pairs representative of the echo signals. The RF or IQ signal data may then be provided directly to the memory 106 for storage (e.g., temporary storage). Optionally, the output of the beamformer processor 130 may be passed directly to the controller circuit 102.

The controller circuit 102 may be configured to process the acquired ultrasound data (e.g., RF signal data or IQ data pairs) and prepare and/or generate frames of ultrasound image data representing the anatomical structure of interest for display on the display 138. Acquired ultrasound data may be processed in real-time by the controller circuit 102 during a scanning or therapy session of the ultrasound exam as the echo signals are received. Additionally or alternatively, the ultrasound data may be stored temporarily in the memory 106 during a scanning session and processed in less than real-time in a live or off-line operation.

The memory 106 may be used for storing processed frames of acquired ultrasound data that are not scheduled to be displayed immediately or to store post-processed images (e.g., shear-wave images, strain images), firmware or software corresponding to, for example, a graphical user interface, one or more default image display settings, programmed instructions, and/or the like. The memory 106 may store medical images such as 3D ultrasound image data sets of the ultrasound data, where such 3D ultrasound image data sets are accessed to present 2D and 3D images. For example, a 3D ultrasound image data set may be mapped into the corresponding memory 106, as well as one or more reference planes. The processing of the ultrasound data, including the ultrasound image data sets, may be based in part on user inputs, for example, user selections received at the user interface 142.

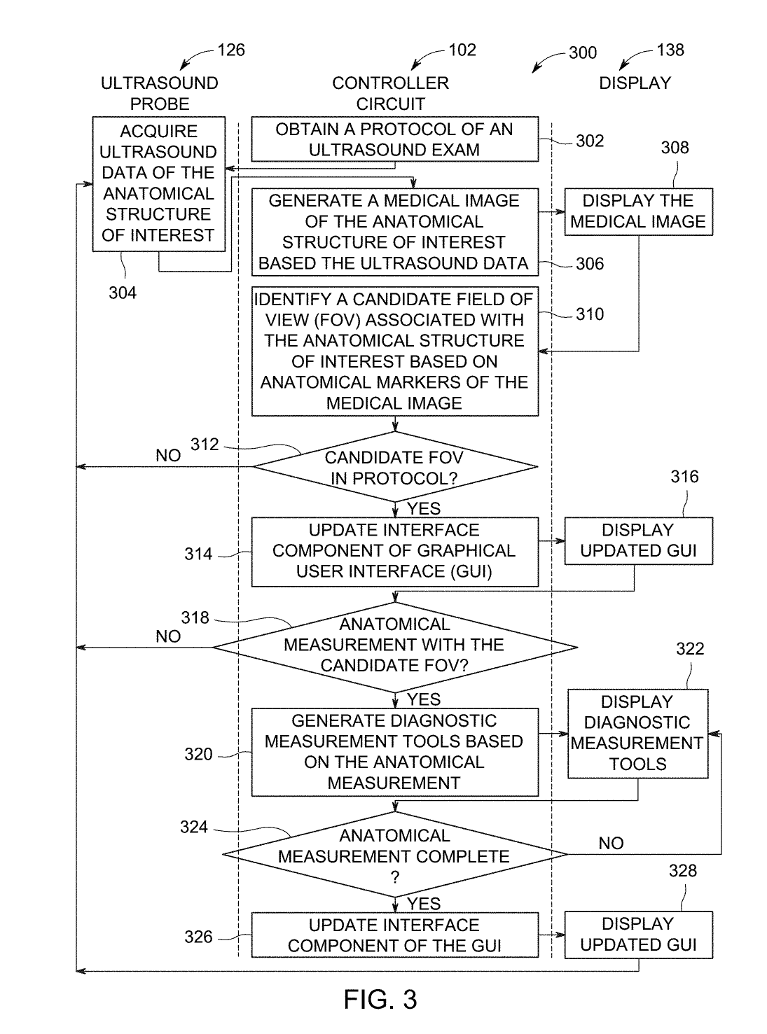

FIG. 3 illustrates a swim lane diagram of an embodiment of a method 300 for acquisition of medical images for an ultrasound exam. The method 300, for example, may employ structures or aspects of various embodiments (e.g., systems and/or methods) discussed herein. In various embodiments, certain steps (or operations) may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. It may be noted that the steps described of the method 300 may be performed during one ultrasound exam in real-time. In various embodiments, portions, aspects, and/or variations of the method 300 may be used as one or more algorithms to direct hardware to perform one or more operations described herein.

Beginning at 302, the controller circuit 102 may be configured to obtain and/or select protocol of an ultrasound exam. The ultrasound exam may correspond to examining the anatomical structure of interest, such as an organ (e.g., heart, kidney, lung, liver, bladder, brain, neonatal brain, embryo, abdomen, and/or the like), vascular structure (e.g., vein), tissue (e.g., breast tissue, liver tissue, cardiac tissue, prostate tissue, and/or the like), bone, and/or the like. The protocol may include a plurality of protocol defined FOVs of the anatomical structure of interest of the ultrasound exam stored in the memory 106. For example, the protocol may include a plurality of medical images corresponding to different FOVs of the anatomical structure of interest. Optionally, one or more of the FOVs may include an anatomical measurement of the anatomical structure of interest. For example, the anatomical measurement may represent a measurement of one or more anatomical markers and/or the anatomical structure of interest of the FOV. The anatomical measurement may represent a volume, an area, a surface area, a wall thickness, a diameter, a blood flow, and/or the like of the anatomical structure of interest and/or one or more anatomical markers of the corresponding FOV.

The protocol may be selected by the controller circuit 102 based on the ultrasound exam and/or the anatomical structure of interest of the ultrasound exam. For example, a protocol database may be stored in the memory 106. The protocol database may have a plurality of ultrasound exams and/or anatomical structures of interest. Each of the ultrasound exams and/or the anatomical structures of interest may have a corresponding protocol. Based on the selected ultrasound exam and/or the anatomical structures of interest, the controller circuit 102 may select the protocol in the memory 106.

Additionally or alternatively, the protocol may be defined by the clinician. For example, the controller circuit 102 may select the protocol based on one or more user selections received from the user interface 142. The clinician may select a plurality of FOVs of the anatomical structure of interest utilizing the user interface 142. For example, the clinician may select one or more user interface components utilizing the user interface 142 to select a FOV of the anatomical structure of interest. The defined protocol by the clinician may be stored in the memory 106.

At 304, the ultrasound probe 126 acquires ultrasound data of the anatomical structure of interest. During the ultrasound exam of the patient, the ultrasound probe 126 may emit ultrasound signals from the transducer array 124 at a set rate within the patient. At least a portion of the ultrasound signals are backscattered from the anatomical structure of interest and received by the ultrasound probe 126 via the receiver 128 as ultrasound data.

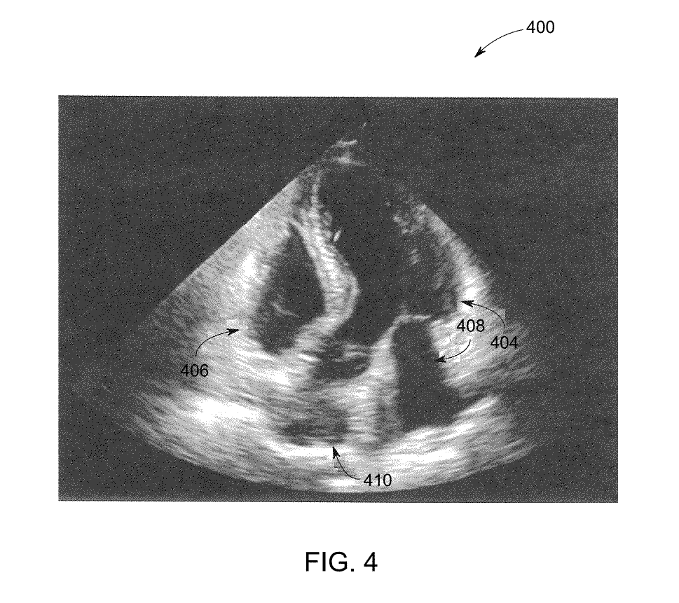

At 306, the controller circuit 102 may be configured to generate a medical image of the anatomical structure of interest based on the ultrasound data. The controller circuit 102 may be configured to process the acquired ultrasound data (e.g., RF signal data or IQ data pairs) from the ultrasound probe 126 and prepare and/or generate frames of ultrasound image data representing the medical image (e.g., a medical image 400 of FIG. 4) of the anatomical structure of interest for display on the display 138.

At 308, the display 138 may display the medical image 400. FIG. 4 illustrates the medical image 400 of an embodiment having an anatomical structure of interest. The medical image 400 may be generated by the controller circuit 102 at 306, and instructs the display 138 to display the medical image 400.

At 310, the controller circuit 102 may be configured to identify a candidate FOV of the anatomical structure of interest based on the medical image 400. For example, the controller circuit 102 may execute the image analysis algorithm configured to identify the FOV of the medical image 400. In connection with FIG. 2, the medical image 400 may correspond to the input image 206. The controller circuit 102 may calculate scores utilizing the artificial neurons in the layers 204 for different categories of the anatomical markers 404, 406, 408, and 410 of the medical image 400 (as described herein). The controller circuit 102 may determine that the anatomical markers 404, 406, and 408 correspond to chambers and the anatomical marker 410 corresponds to a valve of the anatomical structure of interest. Additionally or alternatively, the controller circuit 102 may determine further details of the anatomical markers 404, 406, 408, and 410. For example, the controller circuit 102 may determine based on a size of the chamber 404 of the medical image 400 (FIG. 4) is larger relative to the remaining chambers 406-408, the controller circuit 102 may determine that the chamber 404 corresponds to the left ventricle. Based on the spatial position of the adjacent chambers 406-410 to the chamber 404 and within the medical image 400, the controller circuit 102 may classify the chambers 406-410. For example, since the chamber 406 is positioned adjacent and approximately parallel along a horizontal axis to the chamber 404, the controller circuit 102 may classify the chamber 406 as the right ventricle. In another example, since the chamber 410 is centrally positioned within the medical image 400 and/or is adjacent to all of the chambers 404-408, the controller circuit 102 may classify the chamber 410 as the aortic valve.

Based on the relation between the anatomical markers 404, 406, 408, and 410 the controller circuit 102 may determine the FOV of the anatomical structure of interest of the medical image 400. For example, based on the orientation and distance (e.g., spatial position) of the left ventricle (e.g., the anatomical marker 404), the right ventricle (e.g., the anatomical marker 406), and the aortic valve (e.g., the anatomical marker 410) the controller circuit 102, by executing the image analysis algorithm, may determine that the medical image 400 is a four chamber left ventricle function FOV.

Optionally, the controller circuit 102 may be configured to identify a select image analysis algorithm from a plurality of image analysis algorithms stored in the memory 106 based on the protocol. For example, the plurality of image analysis algorithms are stored in the memory 106. The plurality of image analysis algorithms are defined and/or tailored to different anatomical structures of interest. The controller circuit 102 may select an image analysis algorithm from the plurality of image analysis algorithms in the memory 106 based on the anatomical structure of interest corresponding to the protocol.

At 312, the controller circuit 102 may determine whether the candidate FOV of the medical image 400 is in the protocol. For example, the controller circuit 102 may compare the candidate FOV, such as the four chamber left ventricle function, with the plurality of protocol defined FOVs stored in the memory 106.

If the candidate FOV is not a part of the protocol, the ultrasound probe 126 is configured to acquire additional ultrasound data of the anatomical structure of interest. For example, the controller circuit 102 may continue to acquire ultrasound data in real-time from the ultrasound probe 126. Real-time may correspond to continually acquiring ultrasound data subsequent to the acquisition of the candidate FOV based on a processing speed and/or characteristics of the controller circuit 102. Additionally or alternatively, the controller circuit 102 may be configured to generate an alert on the display 138. The alert may be configured to indicate to the clinician to adjust the ultrasound probe 126 to acquire medical images of a different FOV of the anatomical structure of interest.

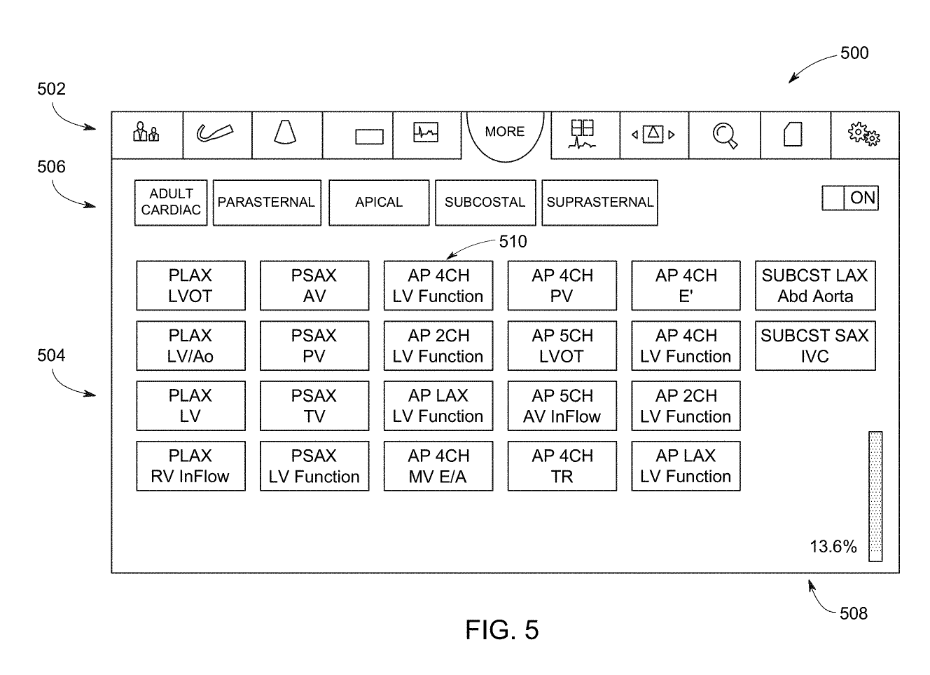

If the candidate FOV is a part of the protocol, then at 314, the controller circuit 102 is configured to update a user interface component 504 of a GUI 500 and store the candidate FOV into the memory 106. FIG. 5 illustrates an embodiment of the GUI 500 shown on the display 138. The GUI 500 includes user interface components 502, 504, 506. The user interface component 502 may represent a menu. The clinician may select and/or activate portions of the user interface component 502 to configure components of the medical imaging system 100. For example, the clinician may adjust acquisition settings of the ultrasound probe 126 based on selections of the user interface component 502.

The user interface components 504 may include a plurality of graphical icons having textual information corresponding to the plurality of protocol defined FOVs that define the protocol. For example, each of the user interface components 504 represent one of the FOVs of the protocol. The textual information may represent anatomical markers within the FOV, the modality of the FOV, the anatomical measurement of the FOV, and/or the like. Optionally, the user interface components 504 may include one or more graphical icons representing the anatomical measurements of the FOV, such as an arrow, cursors, and/or the like. Additionally or alternatively, the user interface components 504 may be shown as a list, a visual representation of the FOV (e.g., a mock-up of a position of the anatomical markers, simulation of the medical image having the FOV, and/or the like), and/or the like.

The controller circuit 102 may be configured to indicating on a graphical user interface (GUI) that the candidate FOV is acquired. For example, the controller circuit 102 indicates on the GUI by adjusting a select characteristic of a first user interface component 510 of the GUI representing the candidate FOV such that the remaining user interface components 504 representing the plurality of protocol defined FOVs do not include the select characteristic. The select characteristic may represent at least one of a color, a position, an animation, a size (e.g., increases or decreases the size relative to the user interface components 504 not acquired), a text format (e.g., bold the text, adjust a color of the text, italicize the test, adjust a size of the text), and/or the like of the first user interface component 510 corresponding to the candidate FOV acquired at 310. For example, the controller circuit 102 may adjust a color, corresponding to the select characteristic, of the first user interface component 510 to indicate that the candidate FOV corresponds to one of the plurality of protocol defined FOVs of the protocol. For example, the controller circuit 102 may adjust a color of the first user interface component 510 from gray to blue, while the remaining user interface components 504 remain having a color of gray. It may be noted that another color may be utilized by the controller circuit 102. Optionally, the controller circuit 102 may adjust a position of the first user interface components 510, such as to a different column and/or position relative to the plurality of protocol defined FOVs of the protocol that have not been acquired corresponding to the remaining user interface components 504. It may be noted as more FOVs of the protocol are acquired, the controller circuit 102 may adjust the select characteristic of more of the user interface components 504 than the first user interface component 510. For example, the controller circuit 102 may be configured to adjust the select characteristic of the user interface components 504 that represent acquired FOVs of the protocol similar to and/or the same as the first user interface component 510.

The user interface components 506 may be utilized by the clinician to adjust an order and/or filter the user interface components 504. For example, each of the user interface components 506 may represent a type and/or category of the plurality of protocol defined FOVs and/or the anatomical measurements of the protocol, such as a parasternal, apical, subcostal, suprasternal, and/or the like. When one of the user interface components 506 are selected, the controller circuit 102 may adjust a position and/or filter the user interface components 504 such that only the FOVs corresponding to the selected user interface component 506 are displayed.

Optionally, the GUI 500 may include an indicator 508. The indicator 508 may be configured to indicate to the clinician how many FOVs and/or anatomical measurements are needed to complete the protocol and/or remaining to complete the protocol. The indicator 508 may be a graphical icon such as a bar (e.g., as shown in FIG. 5), a pie chart, a gauge, and/or the like. The indicator 508 may be color-coded (e.g., such as green, red) to indicate a progression of completion for the protocol. Optionally, the indicator 508 may include textual information such as a percentage, a ratio or number of acquired FOVs and/or anatomical measurements relative to the remaining plurality of protocol defined FOVs and/or anatomical measurements, and/or the like.

Additionally or alternatively, the controller circuit 102 may be configured to determine whether the FOV has already been acquired. For example, the controller circuit 102 may compare the acquired FOV identified at 310 with the FOVs stored in the memory 106. If the FOV has been acquired, the controller circuit 102 may be configured to generate an alert on the display 138. The alert may be configured to indicate to the clinician to adjust the ultrasound probe 126 to acquire medical images of a different FOV of the anatomical structure of interest.

At 316, the display 138 is configured to display the updated GUI 500. For example, the controller circuit 102 may be configured to instruct the display 138 to display the GUI 500 having the updated user interface components 504 indicating the candidate FOV corresponds to one of the plurality of protocol-defined FOVs.

At 318, the controller circuit 102 may be configured to determine whether an anatomical measurement is associated with the candidate FOV. For example, the controller circuit 102 may compare the candidate FOV identified at 310 with the protocol to determine whether the candidate FOV has a corresponding anatomical measurement in the memory 106.

If there is no anatomical measurement with the candidate FOV, the ultrasound probe 126 is configured to acquire additional ultrasound data of the anatomical structure of interest. For example, the controller circuit 102 may continue to acquire ultrasound data in real-time from the ultrasound probe 126 during the ultrasound exam.

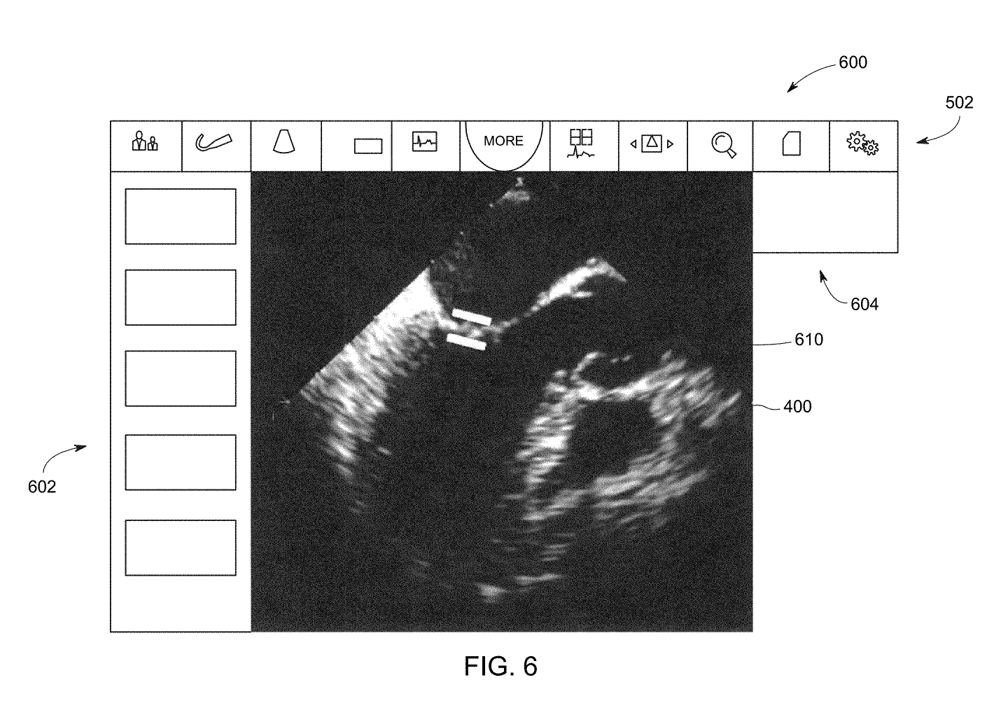

If there is an anatomical measurement with the candidate FOV, then at 320, the controller circuit 102 is configured to generate diagnostic measurement tools 602 based on the anatomical measurement. FIG. 6 illustrates an embodiment of diagnostic measurement tools 602 of a GUI 600 shown on the display 138. The GUI 600 may include the user interface component 502 representing the menu, the medical image 400, the diagnostic measurement tools 602, and a measurement window 604.

The diagnostic measurement tools 602 are configured to enable the clinician to perform one or more anatomical measurements to the anatomical structure of interest based on the medical image 400. For example, the anatomical measurement may represent a measurement of one or more anatomical markers and/or the anatomical structure of interest. The anatomical measurement may represent a volume, an area, a surface area, a wall thickness, a diameter, a blood flow, labeling of anatomical marker or structures of the anatomical structure of interest, and/or the like of the anatomical structure of interest and/or one or more anatomical markers of the shown FOV of the medical image 400. The diagnostic measurement tools 602 may include a plurality of user interface components, which may be selected by the clinician via the user interface 142. Each of the user interface components 502 may enable the clinician to execute the one or more anatomical measurements on the anatomical structure of interest. For example, one of the user interface components 502 when selected by the clinician, may enable the clinician to position and/or overlay cursors 610 on the medical image 400. The controller circuit 102 may be configured to determine a distance between the cursors 610, and display the distance in the measurement window 604. For example, the cursors 610 may be utilized by the clinician to measure dimensions of the anatomical markers and/or the anatomical structure of interest, a thickness, and/or the like. The measurement window 604 may be configured by the controller circuit 102 to display textual information indicative of a distance between the cursors 610. Optionally, the controller circuit 102 may be configured to store the distances in the memory 106 to calculate one or more anatomical measurements, such as an area, volume, and/or the like of the anatomical structure of interest and/or anatomical marker(s). The one or more anatomical measurements may be stored in the memory 106.

Optionally, the controller circuit 102 may automatically activate and/or select the user interface components 502 based on the one or more anatomical measurements of the candidate FOV. For example, the one or more anatomical measurements may represent labeling portions of the anatomical structure of interest. The controller circuit 102 may automatically activate the user interface component 502 corresponding to a labeling tool, which allows the clinician to label structures of the anatomical structure of interest.

Additionally or alternatively, multiple FOVs may have the same anatomical measurement defined by the protocol. The controller circuit 102 may be configured to identify a common anatomical measurement of the candidate FOV previously measured and/or stored in the memory 106. When the controller circuit 102 identifies the common anatomical measurement, the controller circuit 102 may determine that the anatomical measurement is complete and proceed to 326 of the method 300.

At 322, the display 138 is configured to display the diagnostic measurement tools 602. For example, the controller circuit 102 may be configured to instruct the display 138 to display the GUI 600 shown in FIG. 6 having the diagnostic measurement tools 602.

At 324, the controller circuit 102 may be configured to determine whether the anatomical measurement is complete. For example, the controller circuit 102 may display a user interface component, such as within the measurement window 604 and/or the diagnostic measurement tools representing an anatomical measurement confirmation. When the clinician selects the user interface component, representing the anatomical measurement confirmation, the controller circuit 102 may be configured to determine that the anatomical measurement is complete and store the anatomical measurement in the memory 106.

If the anatomical measurement is complete, then at 326, the controller circuit 102 is configured to update the user interface components 504 of the GUI 500. The controller circuit 102 may be configured to indicate that the anatomical measurement is complete on the GUI 500 by adjusting the select characteristic of a select user interface component corresponding to the anatomical measurement. For example, the controller circuit 102 may adjust the select characteristic of the select user interface component relative to the remaining user interface components 504 (FIG. 5) of the GUI 500 representing the anatomical measurements and/or FOVs not acquired. For example, the controller circuit 102 may adjust at least one of a color, a position, an animation, a size (e.g., increases or decreases the size relative to the user interface components 504 not acquired), a text format (e.g., bold the text, adjust a color of the text, italicize the test, adjust a size of the text), and/or the like of the user interface component 504 corresponding to the anatomical measurement acquired at 324.

At 328, the display is configured to display the updated GUI 500. For example, the controller circuit 102 may be configured to instruct the display 138 to display the updated GUI 500 having the updated user interface component 504 indicating the anatomical measurement has been acquired.

It may be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer,” “subsystem,” “controller circuit,” “circuit,” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “controller circuit”.

The computer, subsystem, controller circuit, circuit execute a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer, subsystem, controller circuit, and/or circuit to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a controller circuit, circuit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

1. A computer implemented method, comprising:
selecting a protocol of an ultrasound exam, wherein the protocol includes a plurality of protocol defined fields of view (FOVs) of an anatomical structure of interest;
generating a medical image of the anatomical structure of interest based on ultrasound data acquired from an ultrasound probe;
identifying a candidate FOV associated with the anatomical structure of interest based on anatomical markers of the medical image;
displaying a graphical user interface (GUI) including a plurality of user interface (UI) components, each of the UI components corresponding to a different one of the plurality of protocol defined FOVs; and
automatically adjusting a select characteristic of a first UI component, from the plurality of user interface components that corresponds to the candidate FOV, the select characteristic indicating that the candidate FOV has been acquired and the first UI component is activated.

2. The computer implemented method of claim 1, wherein the identifying operation is based on an orientation of the anatomical markers with respect to each other or a distance between at least two of the anatomical markers.

3. The computer implemented method of claim 1, wherein the protocol includes an anatomical measurement for the candidate FOV and the select characteristic indicates that the first UI component is activated to execute the anatomical measurement.

4. The computer implemented method of claim 3, further comprising generating diagnostic measurement tools based on the anatomical measurement, wherein the select characteristic indicates that the first UI component is activated to execute the diagnostic measurement tools.

5. The computer implemented method of claim 1, further comprising automatically adjusting the select characteristic to indicate that the anatomical measurement is acquired.

6. The computer implemented method of claim 1, wherein the GUI includes an indicator configured to indicate how many protocol defined FOVs are remaining to complete the protocol.

7. The computer implemented method of claim 1, wherein the identifying operation is based on a machine learning algorithm configured to identify the one or more anatomical markers of the medical image.

8. The computer implemented method of claim 1, wherein the anatomical structure of interest includes at least one of a heart, a bone, a brain, a head, a bladder, a kidney, a liver, or a vascular structure.

9. The computer implemented method of claim 1, wherein the select characteristic represents at least one of a color, a position, an animation, a size, or a text format of the first user interface component.

10. A medical imaging system comprising:
an ultrasound probe configured to acquire ultrasound data of an anatomical structure of interest;
a display; and
a controller circuit configured to:
select a protocol of an ultrasound exam, wherein the protocol includes a plurality of protocol defined fields of view (FOVs) of the anatomical structure of interest;
generate a medical image of the anatomical structure of interest based on ultrasound data acquired from an ultrasound probe;
identify a candidate FOV associated with the anatomical structure of interest based on anatomical markers of the medical image; and
display a graphical user interface (GUI) including a plurality of first user interface components, each of the plurality of the UI components corresponding to a different one of the plurality of protocol defined FOVs; and
automatically adjust a select characteristic of ene-of a first UI component, from the plurality of first user interface components that corresponds to the candidate FOV, the select characteristic indicating that the candidate FOV has been acquired and the first UI component is activated.

11. The medical imaging system of claim 10, wherein the controller circuit is configured to identify the candidate FOV based on an orientation of the anatomical markers with respect to each other or a distance between at least two of the anatomical markers.

12. The medical imaging system of claim 10, wherein the GUI includes an indicator configured to indicate how many protocol defined FOVs are remaining to complete the protocol.

13. The medical imaging system of claim 10, wherein the protocol includes an anatomical measurement for the candidate FOV and the select characteristic indicates that the first UI component is activated to execute the anatomical measurement.

14. The medical imaging system of claim 13, wherein the controller circuit is configured to generate diagnostic measurement tools based on the anatomical measurement and the select characteristic indicates that the first UI component is activated to execute the measurement tools.

15. The medical imaging system of claim 10, wherein the select characteristic represents at least one of a color, a position, an animation, a size, a text format of the first user interface component.

16. The medical imaging system of claim 10, wherein the controller circuit is configured to identify the candidate FOV based on a machine learning algorithm configured to identify the one or more anatomical markers of the medical image.

17. The medical imaging system of claim 10, wherein the anatomical structure of interest includes at least one of a heart, a bone, a brain, a head, a bladder, a kidney, a liver, or a vascular structure.

18. A tangible and non-transitory computer readable medium comprising one or more programmed instructions configured to direct one or more processors to:
select a protocol of an ultrasound exam, wherein the protocol includes a plurality of protocol defined fields of view (FOVs) of an anatomical structure of interest;
generate a medical image of the anatomical structure of interest based on ultrasound data acquired from an ultrasound probe;
identify a candidate FOV associated with the anatomical structure of interest based on anatomical markers of the medical image;
display a graphical user interface (GUI) including a plurality of first user interface components, each of the plurality of the UI components corresponding to a different one of the plurality of protocol defined FOVs; and
automatically adjust a select characteristic of a first UI component, from the plurality of first user interface components that corresponds to the candidate FOV, the select characteristic indicating that the candidate FOV has been acquired and the first UI component is activated.

19. The tangible and non-transitory computer readable medium of claim 18, wherein the one or more processors are directed to identify the candidate FOV based on an orientation of the anatomical markers with respect to each other or a distance between at least two of the anatomical markers.

20. The tangible and non-transitory computer readable medium of claim 18, wherein the protocol includes an anatomical measurement for the candidate FOV, and wherein the one or more processors are directed to generate diagnostic measurement tools based on the anatomical measurement.

21. The computer implemented method of claim 1, wherein the first UI component corresponds to a protocol defined operation to be executed upon the candidate FOV, the select characteristic indicating that the first UI component is activated to perform the protocol defined operation.

22. The computer implemented method of claim 21, wherein the select characteristic indicates that the first UI component is activated to perform, as the protocol defined operation, at least one of i) generate a diagnostic measurement tool, or ii) execute an anatomical measurement.

23. The medical imaging system of claim 10, wherein the first UI component corresponds to a protocol defined operation to be executed upon the candidate FOV, the select characteristic indicating that the first UI component is activated to perform the protocol defined operation.

24. The medical imaging system of claim 23, wherein the select characteristic indicates that the first UI component is activated to perform, as the protocol defined operation, at least one of i) generate a diagnostic measurement tool, or ii) execute an anatomical measurement.
